(19) United States
(12) Patent Application Publication
(10) Pub. No.: US 2012/0131131 A1
(43) Pub. Date: May 24, 2012

(54) SHARING OF MOBILE CODE INFORMATION

(75) Inventor: Shu WANG, Richardson, TX (US)

(73) Assignee: SAMSUNG ELECTRONICS CO. LTD., Suwon-si (KR)

(21) Appl. No.: 12/948,996

(22) Filed: Nov. 18, 2010

(51) Int. Cl. G06F 15/16

(52) U.S. Cl. 709/217

(57) ABSTRACT

An apparatus and method for sharing information corresponding to a Mobile Code (MC) by a mobile terminal are provided. The method includes scanning an MC by the mobile terminal, transmitting an identifier of the scanned MC to a server, and transmitting an identity of group members authorized to receive information corresponding to the scanned MC to the server. By sharing information corresponding to an MC according to the present invention, scanning efficiency is improved and duplication of scanning among group members is avoided.

### BACKGROUND OF THE INVENTION

1. Field of the Invention

The present invention relates to an apparatus and method for scanning and sharing a Mobile Code. More particularly, the present invention relates to an apparatus and method for scanning a Mobile Code by a first user and providing information relating to the scanned Mobile Code to a second user.

2. Description of the Related Art

Mobile terminals were originally developed to provide simple wireless communication between users. As technology has advanced, mobile terminals now provide many additional and advanced features beyond the simple telephone conversation. For example, mobile terminals now allow a user to send and receive Electronic mail (Email), receive a multicast or broadcast service, receive and reproduce a Global Positioning System (GPS) signal, receive an Internet service, and the like. Furthermore, mobile terminals are provided with components that enhance the usability of the device. For example, a mobile terminal may be provided with a high quality speaker for use in making conference calls and listening to music files, an advanced display for reproducing high definition video signals and for functioning as a touch screen to receive user input, a high resolution camera to capture still and moving images, and the like.

One advanced feature provided for mobile terminals is the ability to scan, decode, and execute a Mobile Code (MC). An MC may be a 1-Dimensional (1D) barcode, such as a Universal Product Code (UPC), or a 2-dimensional (2D) barcode, such as a data matrix or a Quick Response (QR) code. Furthermore, an MC may provide information either directly or indirectly. That is, an MC may be encoded with specific content or a Uniform Resource Locator (URL) containing an address of a corresponding service so as to provide the information directly, or may indirectly provide information by connecting to a server corresponding to the scanned MC. An advantage of using an MC is that information, such as an application download or other mobile-specific pages, is obtained much quicker as compared to retrieving the information by typing a corresponding request into the mobile terminal.

As technology advances and mobile terminals are able to execute advanced features, such as the ability to scan, decode, and execute an MC, service carriers are responding by researching, developing, and providing corresponding services. However, when many service carriers develop such services, there is a potential that only users subscribing to the same service carrier will be able to exchange information or communicate with each other using the advanced components and features. To alleviate this concern, the Open Mobile Alliance (OMA) was formed to ensure that, regardless of the type of device, service or carrier that a mobile terminal is using, the mobile terminal will be able to communicate and exchange information with other mobile terminals. To this end, members of the OMA develop open, market driven interoperable specifications for global adoption of data services. Once a technology or specification is developed, the OMA issues a service enabler, which is a management object designated for the particular specification or purpose, for use by a mobile terminal. For example, the OMA has issued several service enablers for technologies and purposes such as Email notification, browsing, mobile advertising, and secure content exchange.

Regarding the development and use of MCs, one concern is that different service providers may create and advance specific types of symbols or data formats that would only interact with their systems. In response, the OMA formed a working group to address these concerns and has issued a candidate service enabler to address these potential problems. More specifically, the candidate enabler includes standards regarding the requirements and architecture of MCs.

Currently, the scanning, decoding and use of an MC is treated as a solitary activity. That is, the OMA candidate MC enabler only addresses single-user scenarios. However, as there are constantly more and more users of mobile terminals, it is often that users desire to collaborate in groups and share scanning information during an information seeking process. That is, information discovery is often a social activity. Accordingly, there is a need for an improved apparatus and method for scanning an MC and providing the corresponding information to others.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for scanning a Mobile Code (MC) and sharing the corresponding information.

Another aspect of the present invention is to provide an apparatus and method for scanning an MC by a first user and providing corresponding information to at least another user.

Still another aspect of the present invention is to provide an apparatus and method for scanning an MC by a first user and providing corresponding information to at least another user in either a synchronous or asynchronous manner.

In accordance with an aspect of the present invention, a method for providing a user interface in a mobile terminal having a software mode and a hardware mode is provided. The method includes scanning an MC by the mobile terminal, transmitting an identifier of the scanned MC to a server, and transmitting an identity of group members authorized to receive information corresponding to the scanned MC to the server.

In accordance with another aspect of the present invention, an apparatus for providing a user interface in a mobile terminal having a software mode and a hardware mode is provided. The apparatus includes a controller for scanning an MC, and a transmitter for transmitting an identifier of the scanned MC to a server and for transmitting an identity of group members authorized to receive information corresponding to the scanned MC to the server.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a group scanning architecture according to an exemplary embodiment of the present invention;

FIG. 2 illustrates a flow diagram of a synchronous group sharing process according to an exemplary embodiment of the present invention; and

FIG. 3 illustrates a flow diagram of an asynchronous group sharing process according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The following exemplary embodiments of the present invention are described as applied to a mobile terminal. However, it is to be understood that this is merely a generic term and that the invention is equally applicable to any of a mobile device, a palm sized Personal Computer (PC), a Personal Digital Assistant (PDA), a Hand-held PC (HPC), a smart phone, an International Mobile Telecommunication 2000 (IMT-2000) terminal, a wireless Local Area Network (LAN) terminal, and the like. Accordingly, use of terms such as “mobile terminal” and “mobile station” should not be used to limit application of the present inventive concepts to any certain type of apparatus or device.

Currently, the Open Mobile Alliance (OMA) Mobile Code (MC) enabler is only designed to support single-user scenarios. That is, the OMA MC enabler only supports scanning, decoding, and execution of an MC by a single user such that scanning results are only provided to the user that scanned the MC. However, users often desire to collaborate in a group and share scanning information during an information seeking process. Accordingly, the following exemplary embodiments of the present invention provide an apparatus and method for scanning an MC by a first user and making the scanning results available to at least a second user. That is, exemplary embodiments of the present invention provide an apparatus and method for groups of users to share a scanning experience (e.g., share scanned results, comments on scanned results, and the like).

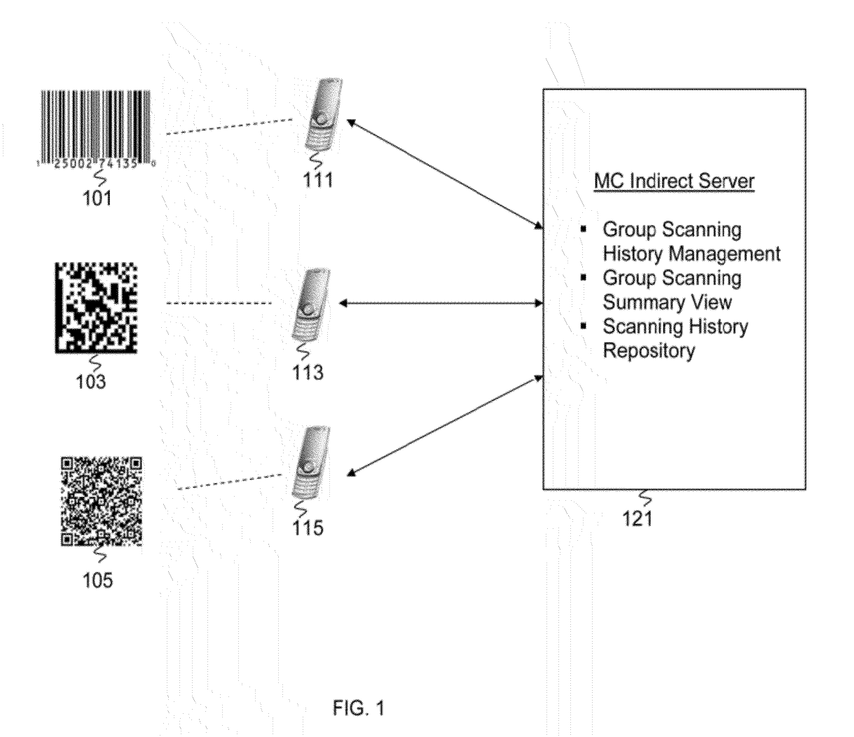

FIG. 1 illustrates a group scanning architecture according to an exemplary embodiment of the present invention.

Referring to FIG. 1, a first Mobile Station (MS) 111, a second MS 113 and a third MS 115 are provided as an example of a plurality of MSs belonging to a group. While the example of FIG. 1 illustrates three MSs constituting the group, it is to be understood that any number of MSs greater than or equal to two may constitute a group. As illustrated in FIG. 1, any of the first MS 111, the second MS 113 and the third MS 115 may scan and decode an MC. In the example of FIG. 1, the first MS 111 scans a first MC 101. In this case, the first MC 101 includes a Universal Product Code (UPC) that is a 1-Dimensional (1D) MC. The second MS 113 scans a second MC 103 and the third MS 115 scans a third MC 105. In this case, both the second MC 103 and the third MC 105 include 2-Dimensional MCs. More specifically, the second MC 103 is a data matrix and the third MC 105 is a Quick Reference (QR) code.

When any of the first MS 111, the second MS 113 or the third MS 115 scans an MC, the corresponding MS decodes the MC and transmits the decoded results to an Indirect MC Server 121. According to an exemplary embodiment of the present invention, the functionality of the Indirect MC Server 121 is extended to not only perform MC resolution, but also to function as a group scanning server.

That is, the Indirect MC Server 121 performs additional functions such as storing and managing scanning results for a user, storing and managing the scanning history for the user, storing meta data associated with the scanning results (e.g. scanning time/date/code-symbology, user comments, ratings, annotations, and the like), creating a summary view of scanning history based on specified rules, sending scanned results to other users of a group, and the like. In this way, the Indirect MC Server 121 facilitates a group scanning experience.

According to exemplary implementations of the present invention, a group scanning experience can be considered to be either synchronous or asynchronous. Synchronous group scanning denotes a process in which a user's scanning processes/results can be synchronized across all group members' devices. In other words, it supports a “one for all” arrangement in which a scan made and processed by a first member of the group is provided for all group members. Moreover, it enables both local and remote group collaborations.

As a first example of synchronous group scanning, it is assumed that a first user is in a mall and notices an MC having a recipe encoded thereon. Knowing that a second user is preparing for a party and would appreciate having this recipe, the first user scans the recipe MC and requests group sharing of the MC. In this case, the MC Indirect Server 121 not only provides the recipe associated with the barcode to the first user, but also sends the recipe information to the second user, who is in a distant and separate location.

As a second example of synchronous group scanning, it is assumed that plurality of users or group members visit a monument. At the monument, the members would like to scan an MC associated with the monument to receive history, background, and other information about the monument. However, only a first member has a mobile terminal that can recognize the mobile code symbology. In this case, the first user enables group scanning capability such that, the first user scans the MC, the decoded results are sent to all the tour group members.

Of course, although the first example only includes one second user that receives the information scanned by the first user, it is to be understood that there can be any number of users that also receive the information. Similarly, the plurality of users in the group of the second example may include any number of users.

Furthermore, the users that are considered part of a group may be designated as group members at any point in the scanning process. That is, members of a group may be determined prior to the scanning of an MC by one of the members. For example, a user may have certain contacts stored within the mobile terminal that are previously designated as members of groups such as “Family,” “Friends,” “Work,” and the like. In that case, when the user scans an MC, the user may be prompted to select group MC sharing and further prompted to select one of the groups already designated in the mobile terminal. Alternatively, after scanning of an MC, the user may be prompted to select group MC sharing and further prompted to create an ad hoc group from any of the various contacts stored within the mobile terminal. Even further, the user may first select an existing group or create an ad hoc group, and then perform the MC scanning.

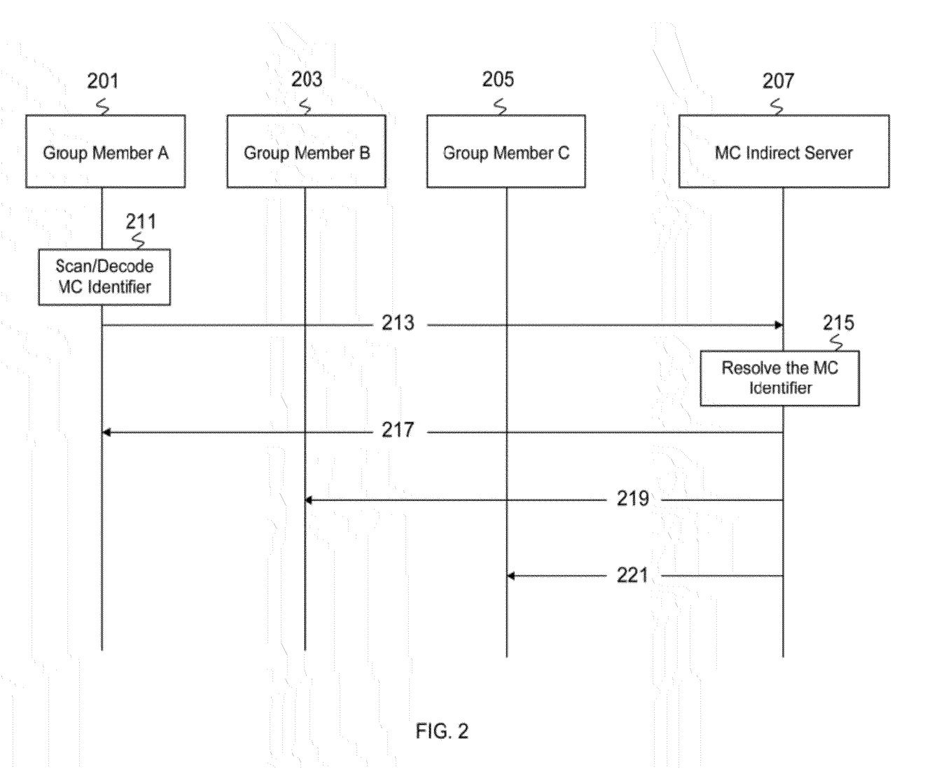

FIG. 2 illustrates a flow diagram of a synchronous group sharing process according to an exemplary embodiment of the present invention.

Referring to FIG. 2, a Group Member A 201, a Group Member B 203, and a Group Member C 205 each represent a mobile terminal user that is a member of a group. As discussed above, the group may be formed at any point of the scanning process. That is, the members of the group may be determined either before or after one of the group members has performed a scanning activity. Moreover, although there are three group members illustrated, it is to be understood that this is merely for descriptive convenience and not to be considered limiting.

In the example of FIG. 2, the Group Member A 201 scans and decodes an MC in step 211. That is, the Group Member A 201 scans either a 1D or 2D barcode and decodes an identifier necessary for retrieval of information. In step 213, the Group Member A 201 transmits the decoded identifier to an MC Indirect Server 207 for resolution. Upon receiving the decoded identifier from the Group Member A, the MC Indirect Server 207 resolves the decoded identifier in step 215, for example by determining information associated with the identifier. Finally, in steps 217, 219 and 221, the MC Indirect Server 207 respectively transmits the decoded results to the Group Member A 201, the Group Member B 203, and the Group Member C 205.

Regarding the management of group functions, the MC Indirect Server 207 may include an OMA group management enabler (e.g., OMA XML Document Management (XDM) enabler) to provide general group management functions. Also, according to an exemplary embodiment of the present invention, the MC Indirect Server 207 may include a module for managing group functions related to an MC scanning and sharing function. Thus, for example, each of Group Member A 201, Group Member B 203, and Group Member C 205 may establish a group service with the MC Indirect Server 207 and set up specific features of that service such as a designation of other users with which the Group Member desires to share scanned information. Furthermore, for each group created by a user, information such as the group identity (e.g., name or label of the group), identities of the members of the group, and the like, may be saved in the module for managing MC group functions. Therefore, when a Group Member scans information and sends the identity of a group with which to share the scanned information to the MC Indirect Server 207, the MC Indirect Server 207 is able to reference the information in the group management module and share the scanned information with appropriate members of the identified group.

According to another exemplary implementation of the present invention, a group scanning experience may be asynchronous.

Asynchronous group scanning denotes a process in which an MC Indirect Server stores and manages information regarding the scanning history for a first user. That is, the MC Indirect Server saves and manages scanning history such as information regarding the scanning time, date, decoded result, barcode symbology, and the like, as well as other information such as user comments, user recommendations, user ratings, and other information about the scanned MC. When an authorized second user later logs on, for example when a second user that is a member of a same group as the first user later logs onto a group scanning session, the second user can see first user's scanning history (e.g. create a summary or filtered view based on a specified criteria). In an alternative exemplary implementation, when the second user scans an MC, the second user can query the history of the MC and see other members' comments about it.

As an example, it is assumed that a first user, a second user, and a third user are senior undergraduates, are actively looking for jobs, and that their school has an upcoming two day job fair. The first user decides to attend the job fair on the first day while the second user and the third user decide to attend on the second day due to class conflicts. While attending the job fair on the first day, the first user scans MCs corresponding to certain companies that the first user visited. As part of the scans, the first user provides comments (e.g., thumbs down, salary too low, and the like). When the second and third users attend the job fair on the second day, they first look at the first user's comments, visit the companies that the first user highly recommended, and/or avoid the companies that received poor reviews from the first user. In this way, the second and third users have a better opportunity to talk with more desirable companies.

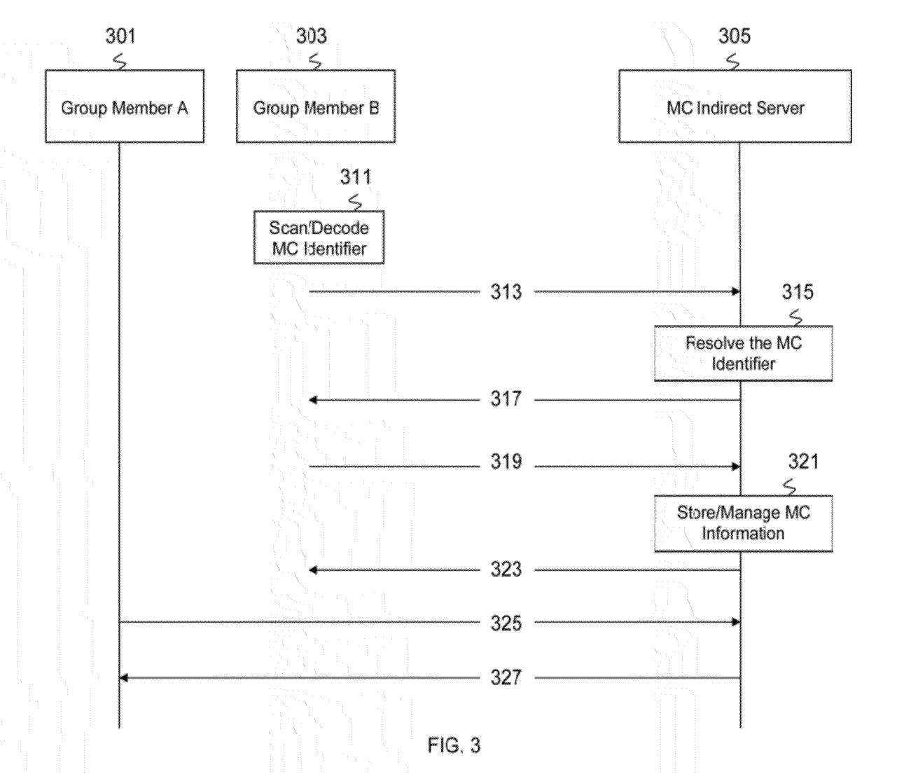

FIG. 3 illustrates a flow diagram of an asynchronous group sharing process according to an exemplary embodiment of the present invention.

Referring to FIG. 3, a Group Member A 301 and a Group Member B 303 each represent a mobile terminal user that is a member of a group. As discussed above, the group may be formed at any point of the scanning process. That is, the members of the group may be determined either before or after one of the group members has performed a scanning activity. Moreover, although there are two group members illustrated, it is to be understood that this is merely for descriptive convenience and not to be considered limiting.

In the example of FIG. 3, the Group Member B 303 scans and decodes an MC in step 311. That is, the Group Member B 303 scans either a 1D or 2D barcode and decodes an identifier necessary for retrieval of information. In step 313, the Group Member B 303 transmits the decoded identifier to an MC Indirect Server 305 for resolution. Upon receiving the decoded identifier from the Group Member B 303, the MC Indirect Server 305 resolves the decoded identifier in step 315, for example by determining information associated with the identifier. In step 317, the MC Indirect Server 305 transmits the resolution results to the Group Member B 303. After receiving the results from the MC Indirect Server 305 in step 317, the Group Member B 303 transmits comments regarding the subject of the MC to the MC Indirect Server 305 in step 319. Referring to the above example, in step 319 the Group Member B 303 may transmit comments regarding a prospective employer such as a potential salary or benefits. Upon receiving the comments from Group Member B 303 in step 319, the MC Indirect Server 305 stores and manages the comments in step 321. For example, the MC Indirect Server 305 may store the comments as associated with the Group Member B 303, or may store the comments as associated with any group of which Group Member B 303 is a member. After the MC Indirect Server 305 has successfully stored and managed the comments provided by the Group Member B 303, the MC Indirect Server 305 transmits an acknowledgement to the Group Member B 303 in step 323.

In step 325, Group Member A 301, being a member of the same group as Group Member B 303 or otherwise authorized to receive history information regarding MCs scanned by Group Member B 303, transmits a query for group scanning history to the MC Indirect Server 305. As an example, the query may be sent automatically by Group Member A 301 upon entering a group scanning session or upon scanning an MC. Furthermore, the query may be selectively sent by Group Member A upon entering the group scanning session or scanning an MC. In step 327, the MC Indirect Server 305 provides the results of the group scanning history query to Group Member A 301. That is, the MC Indirect Server 305 provides stored information associated with an MC, such as other user comments and the like, to the Group Member A 301.

In an exemplary implementation, the Group Member B 303 may execute step 319 at a time that is remote from the execution of steps 311 through 317. That is, the Group Member B 303 may decode an MC identifier and transmit the identifier to the MC Indirect Server 305 at a first time and then end the procedure. At a later time, the Group Member B 303 may access the MC Indirect Server 305 and specifically access the stored MC identifier and transmit comments at that point. In other words, the transmittal of comments in step 319 need not be performed within the same session in which the Group Member B 303 also transmits the MC identifier in step 313.

Exemplary embodiments of the present invention provide an apparatus and method for group collaborative scanning. As discussed above, the invention provides for both remote and local scanning collaboration, provides synchronous and asynchronous sharing of information by a group, supports group awareness and group efforts, improves scanning efficiency, and avoids duplication of scanning among group members.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for sharing information corresponding to a Mobile Code (MC) by a mobile terminal, the method comprising:
scanning an MC by the mobile terminal;
transmitting an identifier of the scanned MC to a server; and
transmitting an identity of group members authorized to receive information corresponding to the scanned MC to the server.

2. The method of claim 1, wherein the transmitting of the identity of the group members comprises transmitting a single identity representing a plurality of the group members.

3. The method of claim 1, wherein the transmitting of the identity of the group members comprises transmitting a corresponding identity for each member of the group.

4. The method of claim 1, further comprising:
receiving the information corresponding to the scanned MC from the server; and
transmitting first additional information pertaining to the scanned MC to the server.

5. The method of claim 4, further comprising:
accessing the server; and
at least one of transmitting second additional information pertaining to the scanned MC to the server and editing the first additional information pertaining to the scanned MC stored by the server.

6. A method for controlling information corresponding to a Mobile Code (MC) by a server, the method comprising:
receiving an identifier of a scanned MC from a first mobile terminal;
resolving the identifier; and
transmitting information corresponding to the scanned MC to at least one mobile terminal other than the first mobile terminal.

7. The method of claim 6, further comprising receiving an identity of the at least one mobile terminal other than the first mobile terminal.

8. The method of claim 7, wherein the receiving of the identity of the at least one mobile terminal other than the first mobile terminal comprises receiving a single identity representing at least one mobile terminal other than the first mobile terminal.

9. The method of claim 7, wherein the receiving of the identity of the at least one mobile terminal other than the first mobile terminal comprises receiving a corresponding identity for each of the at least one mobile terminal other than the first mobile terminal.

10. The method of claim 6, wherein the transmitting of information to the at least one mobile terminal other than the first mobile terminal comprises transmitting the information to each of the at least one mobile terminal other than the first mobile terminal concurrently.

11. The method of claim 6, wherein the transmitting of information to the at least one mobile terminal other than the first mobile terminal comprises transmitting the information to each of the at least one mobile terminal other than the first mobile terminal at distinct times.

12. The method of claim 6, further comprising:
storing information regarding a scanning history of the first mobile terminal.

13. The method of claim 12, wherein the scanning history comprises at least one of a time of scanning the MC, a date of scanning the MC, a decoded result of the scanned MC, a symbology of the scanned MC.

14. The method of claim 13, further comprising providing the scanning history of the first mobile terminal to the at least one mobile terminal other than the first mobile terminal.

15. The method of claim 12, further comprising receiving first additional information pertaining to the scanned MC from the first mobile terminal.

16. The method of claim 15, wherein the first additional information comprises a user comment regarding the scanned MC.

17. The method of claim 16, further comprising transmitting the first additional information to the at least one mobile terminal other than the first mobile terminal.

18. An apparatus in a mobile terminal for sharing information corresponding to a Mobile Code (MC), the apparatus comprising:
a controller for scanning an MC;
a transmitter for transmitting an identifier of the scanned MC to a server and for transmitting an identity of group members authorized to receive information corresponding to the scanned MC to the server.

19. The apparatus of claim 18, wherein the transmitter transmits the identity of the group members by transmitting a single identity representing a plurality of the group members.

20. The apparatus of claim 18, wherein the transmitter transmits the identity of the group members by transmitting a corresponding identity for each member of the group.

21. The apparatus of claim 18, further comprising:
a receiver for receiving the information corresponding to the scanned MC from the server,
wherein the transmitter transmits first additional information pertaining to the scanned MC to the server.

22. The apparatus of claim 21, wherein the controller controls accessing of the server and further wherein the controller controls at least one of transmitting second additional information pertaining to the scanned MC to the server and editing the first additional information pertaining to the scanned MC stored by the server.

23. An apparatus in a server for controlling information corresponding to a Mobile Code (MC), the apparatus comprising:
a receiver for receiving an identifier of a scanned MC from a first mobile terminal;
a controller for resolving the identifier; and
a transmitter for transmitting information corresponding to the scanned MC to at least one mobile terminal other than the first mobile terminal.

24. The apparatus of claim 23, wherein the receiver receives an identity of the at least one mobile terminal other than the first mobile terminal.

25. The apparatus of claim 24, wherein the receiver receives the identity of the at least one mobile terminal other than the first mobile terminal by receiving a single identity representing at least one mobile terminal other than the first mobile terminal.

26. The apparatus of claim 24, wherein the receiver receives the identity of the at least one mobile terminal other than the first mobile terminal by receiving a corresponding identity for each of the at least one mobile terminal other than the first mobile terminal.

27. The apparatus of claim 23, wherein the transmitter transmits information to the at least one mobile terminal other than the first mobile terminal by transmitting the information to each of the at least one mobile terminal other than the first mobile terminal concurrently.

28. The apparatus of claim 23, wherein the transmitter transmits information to the at least one mobile terminal other than the first mobile terminal by transmitting the information to each of the at least one mobile terminal other than the first mobile terminal at distinct times.

29. The apparatus of claim 23, further comprising:
a storage unit for storing information regarding a scanning history of the first mobile terminal.

30. The apparatus of claim 29, wherein the scanning history comprises at least one of a time of scanning the MC, a date of scanning the MC, a decoded result of the scanned MC, a symbology of the scanned MC.

31. The apparatus of claim 30, wherein the controller provides the scanning history of the first mobile terminal to the at least one mobile terminal other than the first mobile terminal.

32. The apparatus of claim 29, wherein the receiver receives first additional information pertaining to the scanned MC from the first mobile terminal.

33. The apparatus of claim 32, wherein the first additional information comprises a user comment regarding the scanned MC.

34. The apparatus of claim 33, wherein the transmitter transmits the first additional information to the at least one mobile terminal other than the first mobile terminal.
